(19) United States
(12) Patent Application Publication
(10) Pub. No.: US 2013/0342662 A1
(43) Pub. Date: Dec. 26, 2013

(54) IMAGE PROCESSING DEVICE, IMAGE PROCESSING METHOD, AND PROGRAM

(71) Applicant: CANON KABUSHIKI KAISHA, Tokyo (JP)

(72) Inventors: Chiaki Kaneko, Yokohama-shi (JP); Masatoshi Ishii, Tokyo (JP)

(21) Appl. No.: 13/918,474

(22) Filed: Jun. 14, 2013

(30) Foreign Application Priority Data
Jun. 21, 2012 (JP) 2012-139989
Apr. 1, 2013 (JP) 2013-076145

(51) Int. Cl. H04N 13/04

(52) U.S. Cl. CPC H04N 13/0422
USPC 348/53

(57) ABSTRACT

By the prior art, it was not possible to cope with a change in the way colors are viewed depending on the posture of a viewer. An image processing device for an image display system including glasses having polarizing elements and an image display device, characterized by having a color correction unit configured to perform color correction processing on image data indicating an image to be displayed based on inclination information of the glasses with respect to a display screen of the image display device.

### BACKGROUND OF THE INVENTION

1. Field of the Invention

The present invention relates to color correction processing in an image display technology.

2. Description of the Related Art

At present, a 3D image display technology that makes a viewer perceive a stereoscopic image by utilizing a binocular parallax has spread. This technology causes a stereoscopic image to be perceived by separately providing images (parallax images) of the same object but different in the way the images are viewed from each other by an amount corresponding to a binocular parallax to the left and right eyes, respectively. Among others, the system that simultaneously uses dedicated glasses (hereinafter, referred to as a “glasses system”) is adopted in a 3D movie theater or in a home 3D television and is widely known. Among such glasses-system 3D image display technologies, for example, in a polarized glasses system, parallax images are output from an image output device, such as an LCD panel, by polarization and the output light is distributed to the left and right eyes using glasses to which polarizing plates are attached, thereby the parallax images are provided to the respective eyes.

Further, the polarized glasses are also used in the simultaneous multi-image display technology to provide different image simultaneously to a plurality of viewers using the same screen. In this case, polarizing plates having characteristics different from glasses to glasses are attached and images output by polarization are distributed to the viewers with these respective glasses, thereby different images are provided to the respective viewers.

In general, in the case of such a glasses-system image display system, because of the viewing angle characteristics of the image output device and the optical characteristics of the glasses, the way colors are viewed changes depending on the viewing position. For example, the way colors of the same output image are viewed is different between the case where the screen (image display screen) on which images are displayed, such as a liquid crystal television, is viewed from the front and the case where the screen is viewed in an oblique direction. As a method for suppressing such a change in colors depending on the viewing position, there is known a technology to correct color reproduction of an image output device according to the sight-line direction. For example, Japanese Patent Laid-Open No. 2009-128381 discloses the technology to suppress the change in colors due to the viewing angle characteristics by estimating the sight-line direction of a viewer in front of the image display screen and by correcting the saturation and lightness of the image to be displayed according to the sight-line direction.

However, it is known that the change in the way colors are viewed in the glasses-system image display technology depends not only on the viewing position but also on the viewer's posture at the time of viewing. For example, colors are viewed differently between the case where the colors are viewed with the viewer's back stretched and the case where the colors are viewed with the viewer's back bent. The technology of the above-described Japanese Patent Laid-Open No. 2009-128381 performs color correction in accordance with the angle formed by the sight-line direction and the normal direction of the image display screen, and therefore, it was not possible to deal with the change in the way colors are viewed depending on the posture of the viewer (change in colors caused by the inclination of the glasses about the sight-line direction as the rotation center).

### SUMMARY OF THE INVENTION

The image processing device according to the present invention is an image processing device for an image display system including glasses having polarizing plates and an image display device, and is characterized by comprising a color correction unit configured to perform color correction processing on image data indicating an image to be displayed based on inclination information of the glasses with respect to the display screen of the image display device.

According to the present invention, it is made possible to display an image for which color reproduction has been performed appropriately in accordance with the inclination of glasses in the glasses-system image display technology.

Further features of the present invention will become apparent from the following description of exemplary embodiments (with reference to the attached drawings).

### BRIEF DESCRIPTION OF THE DRAWINGS

FIG. 1 is a diagram showing an example of a system configuration adopting a glasses-system 3D image display technology according to a first embodiment;

FIG. 2 is a diagram showing an internal configuration of an image processing device;

FIG. 3 is a flowchart showing a flow of a series of pieces of processing in the image processing device according to the first embodiment;

FIGS. 4A and 4B are specific examples of inclination information, wherein FIG. 4A shows a case where a rotation angle θ is 0 degrees and FIG. 4B shows a case where the rotation angle θ is 45 degrees;

FIG. 5 is a flowchart showing a flow of creation of color correction parameters in accordance with the inclination of dedicated glasses according to the first embodiment;

FIG. 6 is a diagram showing the way color measurement is performed on an image output from an image output device;

FIGS. 7A and 7B are specific examples of color measurement data F(L, θref) and F(L, θ);

FIGS. 8A and 8B are diagrams for explaining gamut mapping in the first embodiment, wherein FIG. 8A is a diagram in which each color gamut in a L*a*b color space is represented by a two-dimensional coordinate position of L* and a*, and FIG. 8B shows a specific example of correspondence data F′(L, θ) obtained by gamut mapping;

FIG. 9 is a specific example of an LUT that realizes the correspondence data F′(L, θ);

FIG. 10 is a flowchart showing a flow of creation of color correction parameters in a second embodiment;

FIGS. 11A to 11D are explanatory diagrams of gamut mapping according to the second embodiment, wherein FIG. 11A is a specific example of the correspondence data F′(L0, θ) of a reference lens L0 obtained by gamut mapping, FIG. 11B is a specific example of color measurement data F(L1, θ) of a non-reference lens L1, FIG. 11C is a diagram in which each color gamut in the L*a*b color space is represented by a two-dimensional coordinate position of L* and a*, and FIG. 11D is a specific example of correspondence data F″(L1, θ);

FIG. 12 is a specific example of an LUT that realizes the correspondence data F″(L1, θ);

FIG. 13 is a diagram showing an appearance of a ride attraction according to a third embodiment;

FIG. 14 is an explanatory diagram of a simultaneous multi-image display system;

FIG. 15 is an explanatory diagram of crosstalk;

FIGS. 16A and 16B are specific examples of the color measurement data F(L, θ) and F(R, θ) of a display device according to a fourth embodiment;

FIGS. 17A and 17B are specific examples of color measurement data G(L, θ) and G(R, θ) of crosstalk according to the fourth embodiment;

FIG. 18 is a flowchart showing a flow of a series of pieces of processing in an image processing device according to the fourth embodiment; and

FIG. 19 is a graph showing a crosstalk correction efficient W(θ) according to a fifth embodiment.

### DESCRIPTION OF THE EMBODIMENTS

### First Embodiment

In the present embodiment, by performing color correction (color conversion) using color correction parameters in accordance with an inclination of glasses on image data to be displayed on an image display screen of an image output device, corrected image data for which color reproduction has been performed appropriately is generated.

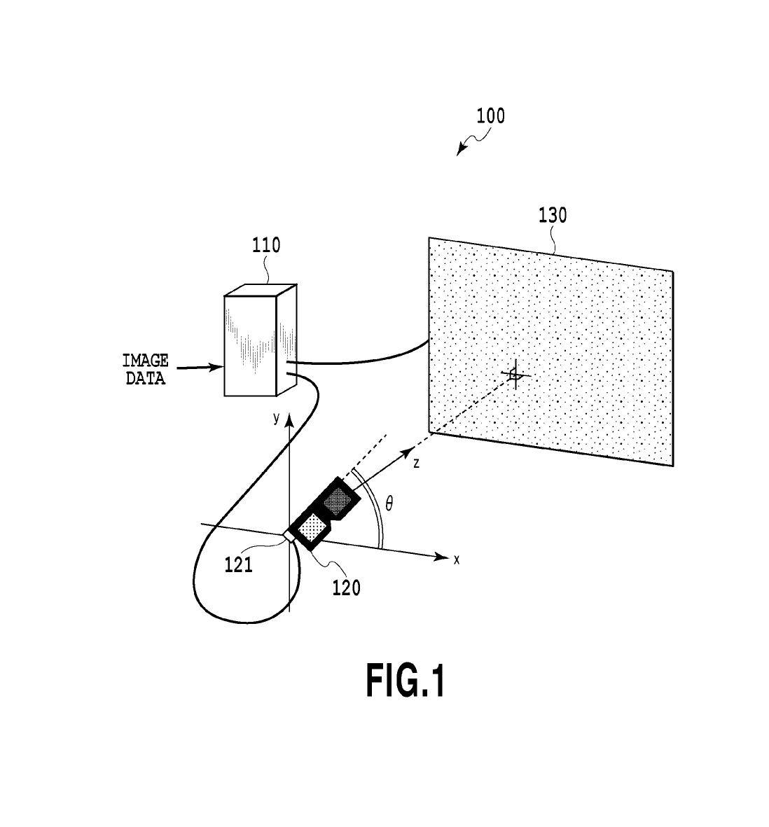

FIG. 1 is a diagram showing a system configuration example adopting the glasses-system 3D image display technology according to the present embodiment.

A 3D image display system 100 includes an image processing device 110 that generates corrected image data by performing color correction processing on input image data, dedicated glasses 120 using circular polarizing plates as lenses, and a liquid crystal display 130 as an image output device.

Image data for a 3D display input from a digital camera etc. is subjected to color correction processing in the image processing device 110 in accordance with information from an inclination sensor 121 provided on the dedicated glasses 120 and the image data is output to and displayed on the liquid crystal display 130. Hereinafter, detailed explanation is given below.

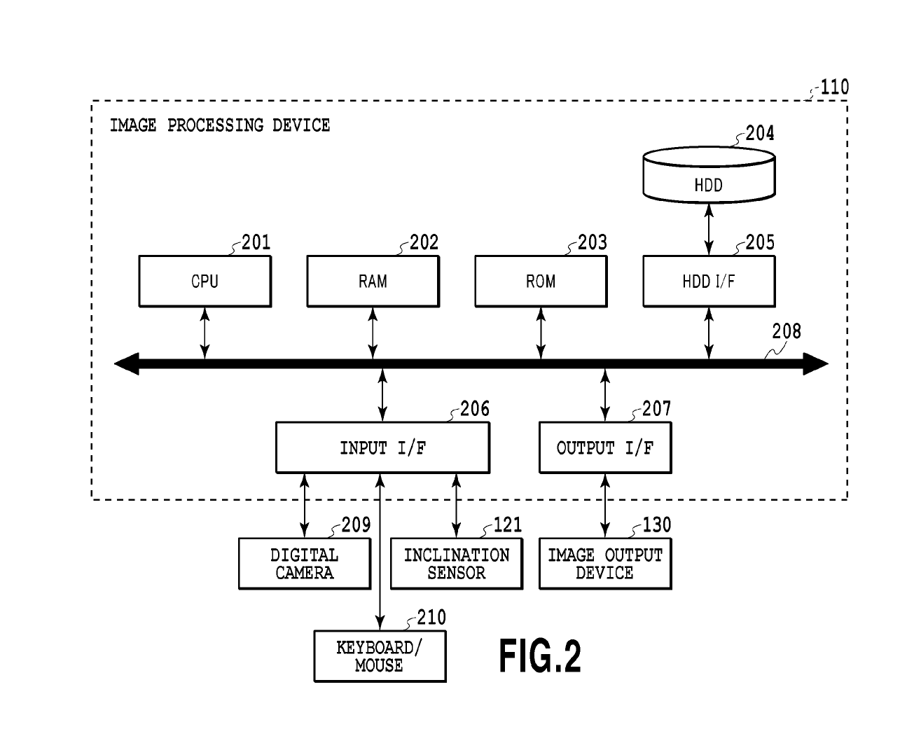

FIG. 2 is a diagram showing an internal configuration of the image processing device 110.

The image processing device 110 includes a CPU 201, a RAM 202, a ROM 203, a hard disk drive (HDD) 204, an HDD I/F 205, an input I/F 206, an output I/F 207, and a system bus 208.

The CPU 201 executes programs stored in the ROM 203 and the HDD 204 using the RAM 202 as a work memory and totally controls each configuration, to be described later, via the system bus 208. Due to this, various kinds of processing, to be described later, are performed.

The HDD interface (I/F) 205 is, for example, an interface, such as serial ATA (SATA), and connects the HDD 204 as a secondary storage device. The CPU 201 is able to read data from the HDD 204 and write data to the HDD 204 via the HDD (I/F) 205. Further, the CPU 201 is able to develop data stored in the HDD 204 on the RAM 204, and similarly to save the data developed on the RAM 202 in the HDD 204. Then, the CPU 201 is able to execute the data developed on the RAM 202 by regarding the data as a program. The secondary storage device may be other storage device, such as an optical disk drive, in addition to the HDD.

The input interface (I/F) 206 is a serial bus interface, such as, for example, USB and IEEE1394. The input I/F 206 connects a digital camera to capture a parallax image, various kinds of input device, such as a keyboard/mouse 210 for a user to give various kinds of operation instructions, and the inclination sensor 121 including an acceleration sensor or an angle speed sensor. The CPU 201 is able to acquire various kinds of data from the various kinds of input device and the inclination sensor 121 via the input I/F 206. The digital camera 209 is an example of a device capable of capturing a parallax image and it is needless to say that other device, such as a video camera, may be used.

The output interface (I/F) 207 is an image output interface, such as, for example, DVI and HDMI, and connects the liquid crystal display device 130 as an image output device. Image data is sent to the liquid crystal display device 130 via the output I/F 207 and a parallax image is displayed on the screen. In the system shown in FIG. 1, the liquid crystal display device 130 is used as an image output device, however, this is not limited. For example, it may also be possible to use a plasma display and an organic EL display in place of the liquid crystal display device, and further, it may also be possible to use a system of type configured to display a parallax image on a screen using a projector. The present invention can be applied widely in the glasses-system 3D image display technology.

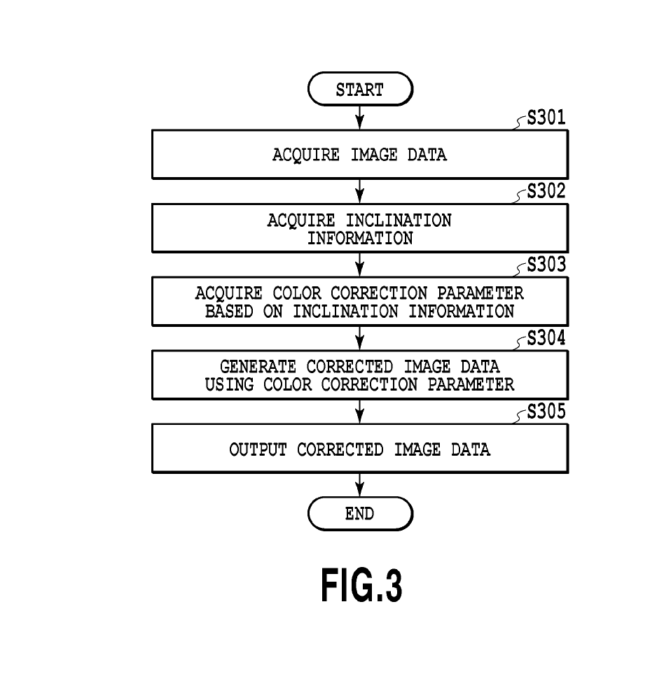

FIG. 3 is a flowchart showing a flow of a series of pieces of processing in the image processing device 110 according to the present embodiment. In the present embodiment, information indicating how much the dedicated glasses 120 are inclined from a reference (hereinafter, called “inclination information”) is acquired by the inclination sensor 121, and color correction in accordance with the inclination of the dedicated glasses 120 is performed on input image data. In the following, explanation is given on the assumption that a viewer stands facing the liquid crystal display device 130. The series of pieces of processing is performed by the CPU 201 executing a computer executable program in which a procedure to be shown below is described after reading the program from the ROM 203 or the HDD 204 onto the RAM 202.

At step 301, the CPU 201 acquires image data to be displayed on the liquid crystal display device 130. For example, it may also be possible to acquire image data from the digital camera 209 via the input I/F 206 or to acquire image data saved in a secondary storage device, such as the HDD 204, via the HDD I/F 205. Image data to be acquired (input) is parallax image data including two kinds of image, that is, a left-eye image and a right-eye image as described previously.

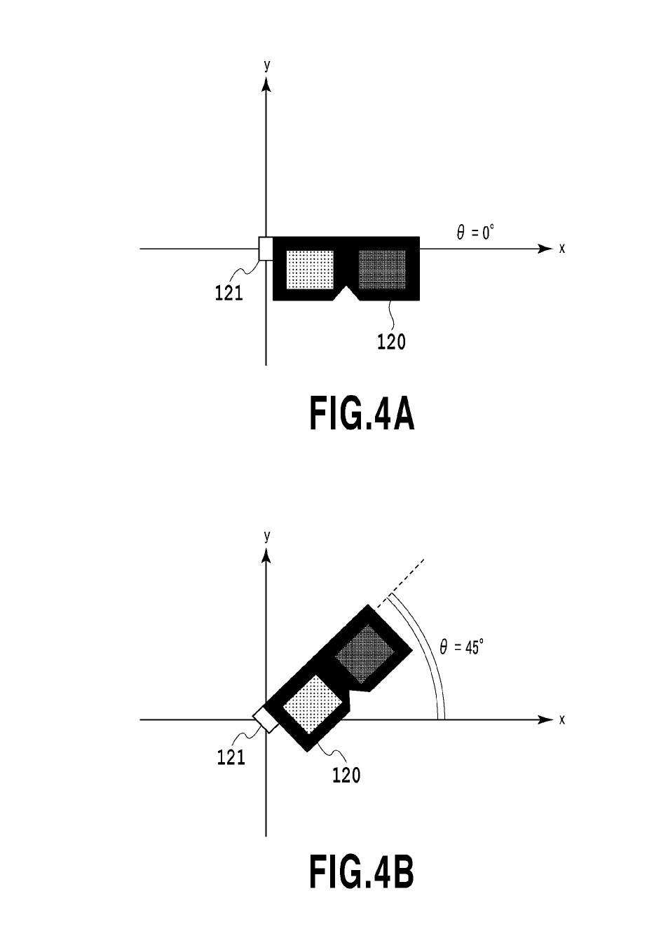

At step 302, the CPU 201 acquires the inclination information of the dedicated glasses 120 from the inclination sensor 121. This inclination information is a rotation angle of the dedicated glasses 120 relative to the horizontal axis in the plane parallel to the image display screen of the image output device. The CPU 201 regards the horizontal direction, the vertical direction, and the normal direction of the image display screen as an x-axis, a y-axis, and a z-axis, respectively, and acquires a rotation angle (angle at the time of viewing obtained from the inclination sensor 121) 0 about the z-axis with the x-axis (horizontal axis) as a reference (see FIG. 1). FIGS. 4A and 4B are diagrams showing a specific example of inclination information and FIG. 4A shows a case where the rotation angle θ is 0 degrees and FIG. 4B shows a case where the rotation angle θ is 45 degrees, respectively.

In the example in FIGS. 4A and 4B, the inclination sensor 121 attached directly to the dedicated glasses 120, however, the method for acquiring inclination information is not limited to this. For example, it may also be possible to regard that the inclination of the dedicated glasses 120 agrees with the inclination of the head of a viewer and to acquire inclination information by attaching the inclination sensor 121 to an accessory (headset, earphone, etc.) fixed on the head of the viewer. Alternatively, it may also be possible to fix the inclination sensor 121 directly to the head itself of the viewer. Further, it may also be possible to provide an extra camera that captures an image of the viewer' face in place of the inclination sensor 121, estimate an inclination of the face using a well-known face recognition technique for the obtained face image, and acquire inclination information based on the estimated inclination.

Explanation is returned to the flowchart in FIG. 3.

At step 303, the CPU 201 acquires color correction parameters used for color correction for a left-eye image and a right-eye image, respectively, based on the acquired inclination information. Specifically, the CPU 201 acquires the color correction parameter for the left-eye image and the color correction parameter for the right-eye image corresponding to the rotation angle θ indicated by the acquired inclination information from the HDD 204. Here, it is assumed that in the HDD 204, color correction parameters associated with a plurality of angles are created and held in advance for the respective left and right lenses of the dedicated glasses 120. For example, it is assumed that color correction parameters associated with each angle (five-degree intervals), for example, from −70 degrees to +70 degrees are created and held for the respective left and right lenses. At this time, in a case where the inclination (=viewing angle θ) of the dedicated glasses 120 is +20 degrees, the color correction parameter for the left-eye image corresponding to θ=+20 degrees of the left-eye lens and the color correction parameter for the right-eye image corresponding to θ=+20 degrees of the right-eye lens are selected, respectively. Details of the method for creating color correction parameters will be described later.

In the case where the color correction parameters are created at five-degree intervals as describe above, there is a real possibility that the color correction parameter corresponding to the acquired inclination information (angle θ) does not exist. In this case, interpolation processing is performed using two color correction parameters corresponding to two angels (θ0 and θ1) that satisfy θ0<θ<θ1 and the color correction parameter corresponding to the acquired inclination information is derived. For example, in the example described above, in a case where the angle θ indicated by the acquired information is +22 degrees, interpolation processing is performed using two color correction parameters associated with the angles θ0 and θ1 by taking θ0=+20 degrees and θ1=+25 degrees. In this manner, the color correction parameter corresponding to the inclination of +22 degrees is derived and this is determined to be the color correction parameter to be used. Further, in a case where the color correction parameters corresponding to the angles θ0 and θ1 do not exist, the color correction parameter of an angle closest to the acquired inclination information (angle θ) is selected and determined to be the color correction parameter to be used. For example, in a case where the angle θ indicated by the inclination information is +80 degrees, the color correction parameter corresponding to +70 degrees the closest to +80 degrees of the existing angles is selected as the color correction parameter to be used. In the case where the color correction parameter is provided in advance, the range or intervals of the angle are not limited to the above-described example and the range may be wider (for example, between −90 degrees and +90 degrees), or on the contrary, may be narrower (for example, between −50 degrees and +50 degrees). Further, the range of angle may be one whose upper limit and lower limit are not symmetric about 0 degrees (for example, between −70 degrees and +60 degrees) and the intervals of angle may be irregular (for example, two-degree intervals between −20 degrees and +20 degrees, and in the rest of the range to the upper limit/lower limit, five-degree intervals, etc.)

Explanation is returned to the flowchart in FIG. 3.

At step 304, the CPU 201 performs conversion (color correction) on the pixel value of the input parallax image data using the acquired color correction parameter and generates corrected image data. Similar to the input parallax image data, the corrected image data also includes a left-eye corrected image and a right-eye corrected image. In this case, in a case where there is an RGB value not corresponding to a color correction parameter (that is, which does not agree with a lattice point) within the input parallax image data, it may possible to acquire the pixel value of each corrected image by performing interpolation processing, such as tetrahedral interpolation, from lattice points in the vicinity thereof.

At step 305, the CPU 201 sends the generated corrected image data to the liquid crystal display 130. Then, on the liquid crystal display 130, the corrected image data is displayed.

Ina case where the input image data acquired at step 301 is motion picture data, it is required only to perform color correction in accordance with a posture of a viewer at all times by detecting the inclination of the dedicated glasses 120 real time to update the inclination information at any time during the period from the start of the display of the motion picture data until the end.

### <Creation of Color Correction Parameter>

The color correction parameters held in the HDD 204 etc. are those by which a group of target colors determined in advance are reproduced. In the present embodiment, color correction parameters, by which the display colors in a case where the image display screen of the liquid crystal display 130 is viewed at a reference angle θref are reproduced also in a case where the colors are viewed at other viewing angle θ, are created for each lens of the dedicated glasses 120. Here, it is assumed that the reference angle θref is, for example, 0 degrees at which the dedicated glasses 120 are parallel to the ground surface (see FIG. 4A). Alternatively, it may also be possible to take an angle at which the reproducible range, such as the luminance range and the color gamut of the display colors in a case where the image display screen is viewed through a lens, is the narrowest to be the reference angle θref. In this case, the possibility that the display colors at the reference angle θref are included in the color gamut at other viewing angle θ becomes strong, and therefore, colorimetric color reproduction becomes easier.

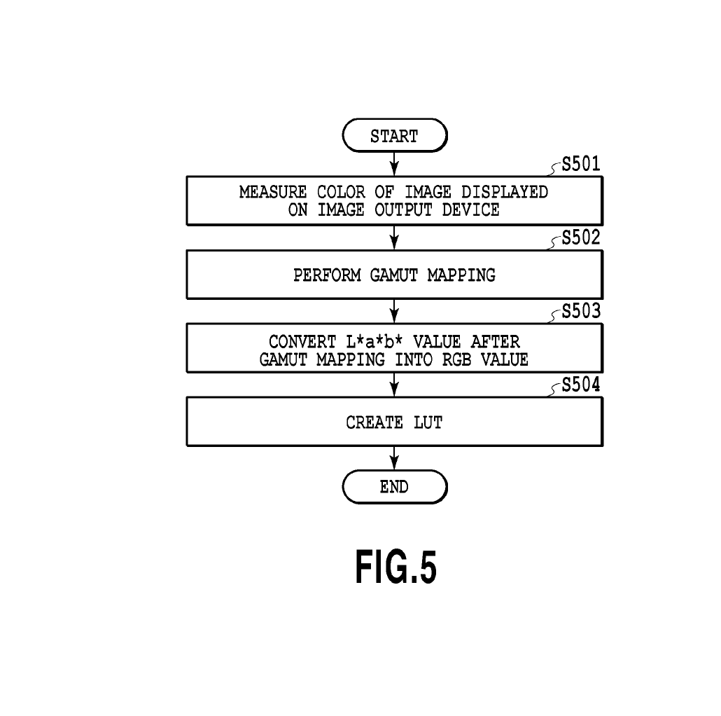

FIG. 5 is a flowchart showing a flow of creation of color correction parameters in accordance with the inclination of the dedicated glasses 120 in the present embodiment. In the present embodiment, a three-dimension color conversion lookup table (hereinafter, referred to simply as “LUT”), in which a correspondence relationship at the time of conversion from the RGB value of an input image to the RGB value of a corrected image is described, is acquired as color correction parameters.

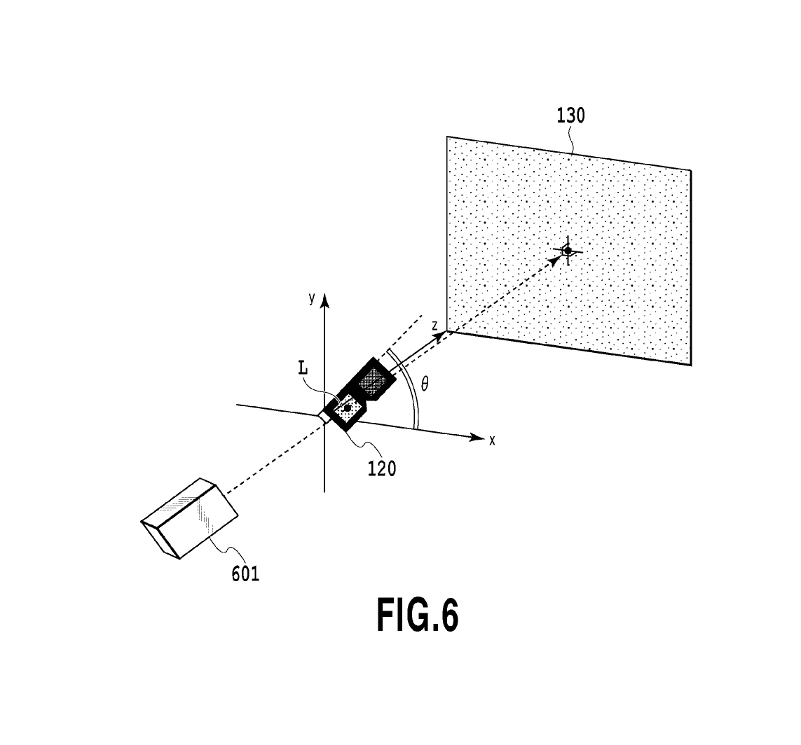

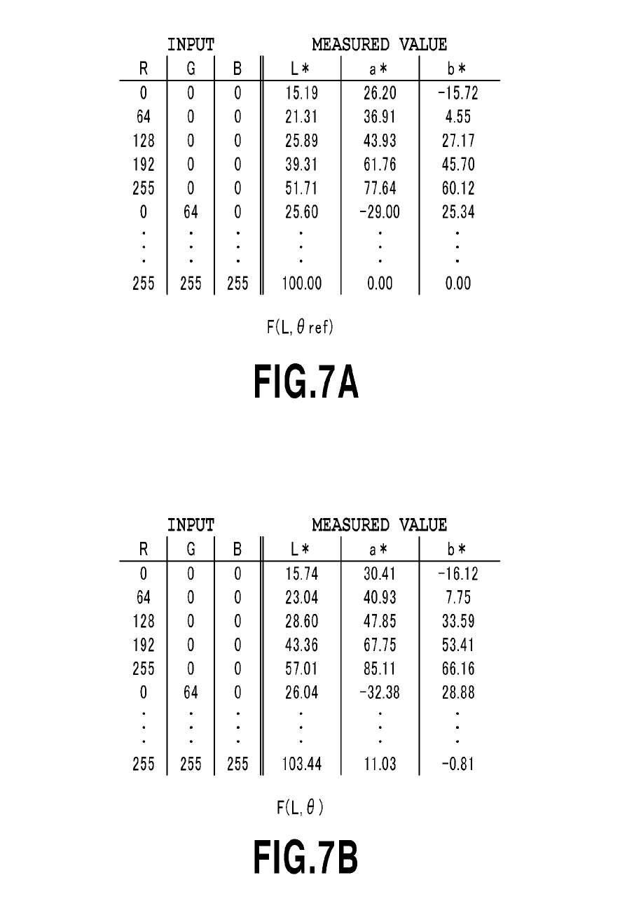

First, at step 501, the RGB value corresponding to each lattice point generated by dividing the RGB color space into the form of a lattice is input to and displayed on the liquid crystal display 130, which is an image output device, and the color of the image display screen is measured. For color measurement, for example, a spectroradiometer is used, and the dedicated glasses 120 is set to the reference angle θref and a predetermined viewing angle θ, and color measurement is performed through a lens, respectively. FIG. 6 is a diagram showing the way color measurement is performed and the color of the image display screen of the liquid crystal display 130 is measured by a spectroradiometer 601 through a left-eye lens L of the dedicated glasses 120 inclined to the predetermined viewing angle θ. Then, such color measurement is performed repeatedly on the viewing angle θ at arbitrary intervals and in an arbitrary range, and an obtained XYZ value is converted into an L*a*b* value, and thus, color measurement data F(L, θref) and F(L, θ) in which the converted L*a*b* value and the RGB value of the lattice point are associated are obtained. FIGS. 7A and 7B show specific examples of the color measurement data F(L, θref) and F(L, θ), respectively, obtained in this manner.

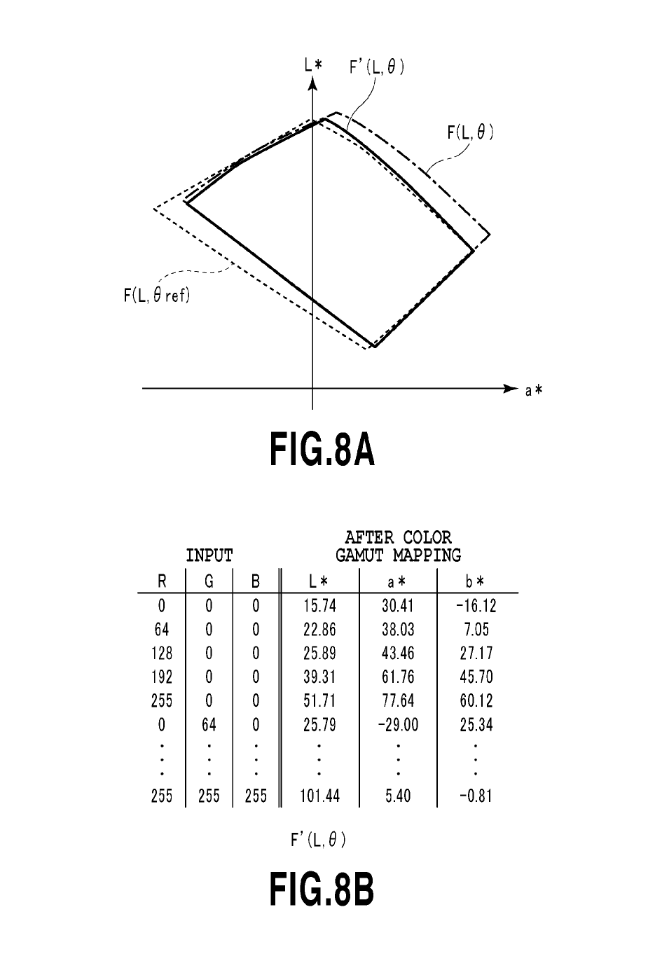

At step 502, gamut mapping processing is performed on the color measurement data F(L, θref) relating to the reference angle θref. Specifically, gamut mapping is performed so that the color measurement data F(L, θref) at the reference angle θref is included in the color gamut indicated by the color measurement data and F(L, θ) at each viewing angle θ. This is performed in order to convert all the L*a*b values included in the color gamut of the reference angle θref, although not included in the color gamut of the viewing angle θ, into the L*a*b values that can be reproduced in the color gamut of the viewing angle θ. By this gamut mapping processing, correspondence data F′(L, θ) between the RGB values at lattice points and the L*a*b values after gamut mapping is obtained. FIGS. 8A and 8B are diagrams for explaining gamut mapping in the present embodiment and FIG. 8A is a diagram representing each color gamut in the L*a*b color space by the two-dimensional coordinate position of L* and a*. In FIG. 8A, the broken line corresponds to the color measurement data F(L, θref) at the reference angle θref shown in FIGS. 7A and 7B and the alternate long and short dash line corresponds to the color measurement data F(L, θ) at the specific viewing angle θ. Gamut mapping is performed so that the color measurement data F(L, θref) at the reference angle θref is included in the color measurement data F(L, θ) at the specific viewing angle θ, thereby the correspondence data F′(L, θ) indicated by the solid line is obtained. FIG. 8B shows a specific example of the correspondence data F′(L, θ) obtained by this gamut mapping. There are various kinds of gamut mapping method and, for example, as a method for obtaining perceptual matching, there is known a method for maintaining properties of gradation by colorimetric reproducing colors in the color gamut with as less compression as possible, and compressing colors outside the color gamut into a high saturation part within the color gamut.

At step 503, the L*a*b value in the correspondence data F′(L, θ) obtained at step 502 is converted into the RGB value using the color measurement data F(L, θ) obtained at step 501. That is, the L*a*b value after gamut mapping is converted into the RGB value based on the correspondence relationship between the RGB value at the lattice point and the L*a*b value for which color measurement has been performed through the lenses of the glasses at the specific viewing angle θ. Specifically, the RGB value at the lattice point is converted into an L*a*b value p after gamut mapping by inputting the RGB value to the F′(L, θ) and further, inversely converting the p into the RGB value using a formula (1) below.

$$RGB value after color correction = {\sum }_{i = 0}^{3} {wiF}_{L}^{- 1} ( Pi ) \qquad [ Formula 1 ]$$

The RGB value obtained through such processing will be the RGB value after color correction for the RGB value of the lattice point.

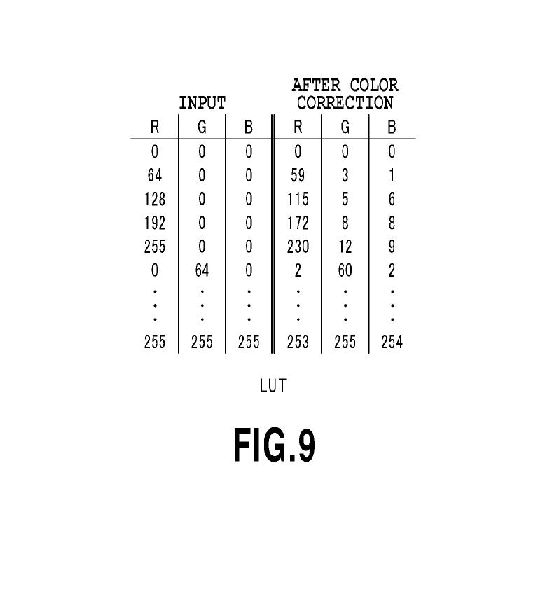

At step 504, an LUT at the specific viewing angle θ is created, in which the RGB values of lattice points and the RGB values after conversion obtained at step 503 are associated. FIG. 9 is a specific example of the LUT that realizes the correspondence data F′ (L, θ) shown in FIGS. 8A and 8B. In the case of this LUT, for example, in a case where a value of a certain pixel in the input image data is (R, G, B)=(64, 0, 0), the value of the pixel in the corrected image data is corrected to (R, G, B)=(59, 3, 1) as a result.

Then, the processing from step 501 to step 504 described above is performed for various viewing angles θ and the series of pieces of the processing is performed for each lens, thereby a plurality of LUTs comprehensively covering the viewing angle θ in a predetermined range is created.

In the present embodiment, the color correction parameters are explained using the three-dimensional color conversion LUT with the RGB value as a reference, however, the color space representing an image is not limited to the RGB. For example, it may also be possible to use the CMYK or other device-dependent color space, or to use color spaces different between the input and output of the LUT. Further, besides the three-dimensional color conversion LUT, it may also be possible to use a conversion matrix or a conversion function that associates the signal value of the corrected image with the signal value of the input image, and by such a method, it is also possible to obtain the same effect.

According to the present embodiment, color correction is performed in accordance with the inclination of the glasses, and therefore, it is made possible to suppress the change in color depending on the viewing posture.

### Second Embodiment

In the first embodiment, the aspect in which the input image data is subjected to color correction in accordance with the inclination of the glasses to output is explained.

However, in general, the dedicate glasses used in the glasses-system 3D image display system distributes parallax images output by light having different characteristics to the left and right eyes, and therefore, the optical characteristics are different between the left and right lenses. Because of this, the color gamut that can be reproduced through a lens and the way colors change depending on the viewing angle are different between the left and right lenses, and therefore, there is a possibility that colors are viewed differently between the left and right lenses depending on the color gamut shape even in the case where color correction is performed using the color correction parameters in accordance with the inclination of the dedicated glasses for the left and right parallax images, respectively. Then, as the difference in the way colors are viewed between the left and right lenses becomes larger, there may be a case where it is difficult to perceive a stereoscopic image because a phenomenon called binocular rivalry occurs.

In view of the above, an aspect is explained as a second embodiment, in which correction is performed using color correction parameters by which not only the difference in the way colors are viewed depending on the inclination of glasses explained in the first embodiment, but also the difference in the way colors are viewed between the left eye and the right eye (between both eyes) becomes small.

The explanation of the series of pieces of processing in the image processing device 110 common to those in the first embodiment is omitted and here, a method for creating color correction parameters, which is a different point, is explained mainly.

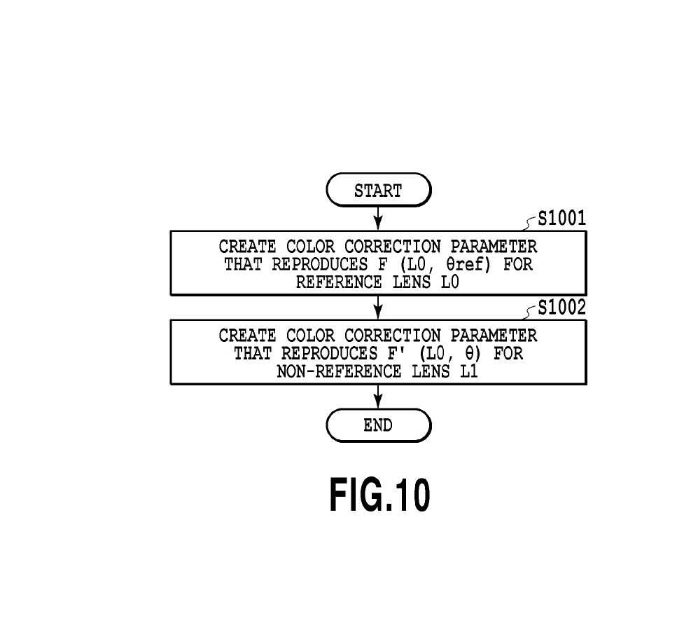

FIG. 10 is a flowchart showing a flow showing creation of color correction parameters in the present embodiment.

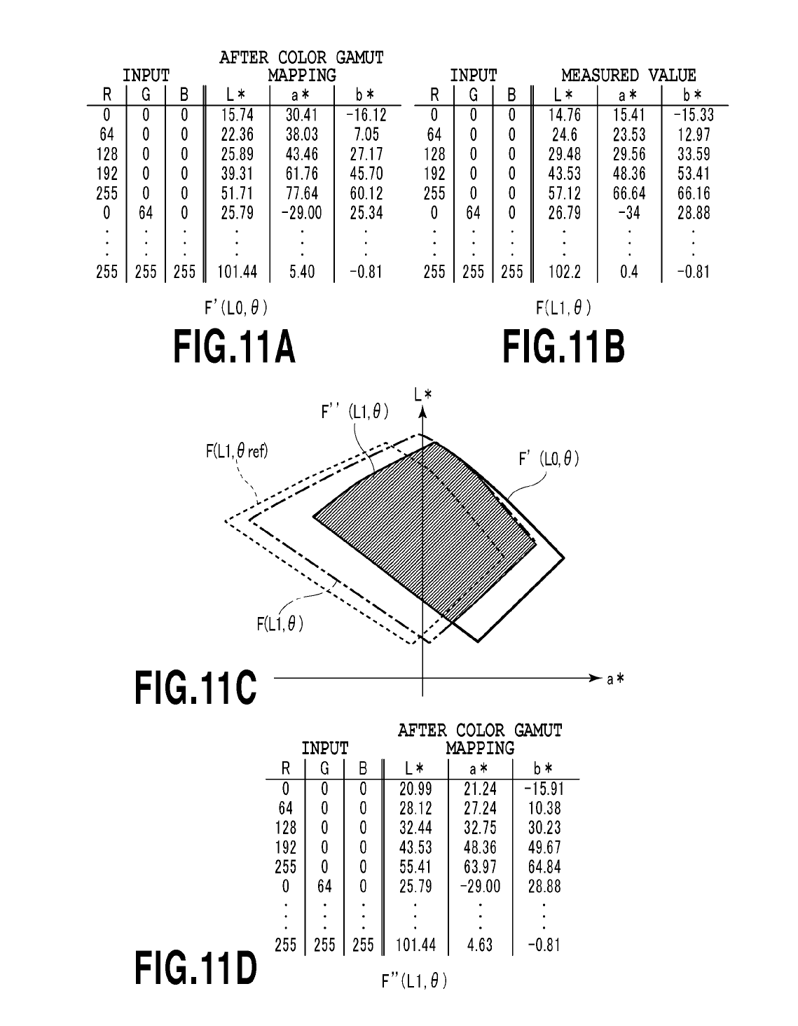

At step 1001, color correction parameters are created by the method explained in the first embodiment for a lens L0 used as a reference lens of the left and right lenses (hereinafter, referred to as a “reference lens”). Specifically, by the procedure shown in the flowchart in FIG. 5, the three-dimensional color conversion LUT for reproducing display colors in the case where the image display screen is viewed through the glasses at the reference angle θref is created. The correspondence data between the RGB values obtained at step 502 and the L*a*b* values after gamut mapping is taken to be F′ (L0, θ). FIGS. 11A to 11D are explanatory diagrams of gamut mapping according to the present embodiment and 11A shows a specific example of the correspondence data F′(L0, θ) of the reference lens L0 obtained by gamut mapping at this step (the contents are the same as those in FIG. 8B according to the first embodiment for the sake of convenience).

Here, it is supposed that the reference lens L0 is, for example, the lens on the dominant eye side of a viewer. It may also be possible to constitute the system so that a viewer specifies information on the dominant eye via a UI displayed on the liquid crystal display etc., which is an image output device, or the dominant eye is automatically determined by displaying parallax image data for determining the dominant eye (for example, see the second embodiment in Japanese Patent Laid-Open No. 2007-034628). Further, it may also be possible to select, as the reference lens L0, a lens, for example, having a narrower luminance range or a smaller color gamut on average for each viewing angle θ, based on the display color reproducible range in the case where the image display screen is viewed through the lens.

At step 1002, color correction parameters for reproducing display colors in a case where the image display screen after color correction is viewed through the reference lens L0 at various viewing angles θ are created for the other lens L1 which is not used as the reference lens (hereinafter, referred to as a “non-reference lens”). Specifically, as follows.

First, color measurement data F(L1, θ) through the non-reference lens L1 at a predetermined viewing angle θ is obtained (step 501 in the flowchart in FIG. 5). FIG. 11B shows a specific example of the color measurement data F(L1, θ) of the non-reference lens L1.

Next, gamut mapping processing is performed on the correspondence data F′(L0, θ) after gamut mapping relating to the reference lens L0 obtained at step 1001 so that the correspondence data F′(L0, θ) is included in the color gamut indicated by the color measurement data F(L1, θ) of the non-reference lens L1 (step 502 in the flowchart in FIG. 5). That is, the part where the color measurement data F(L, θref) is used in the first embodiment is replaced with the correspondence data F′(L0, θ) of the reference lens L0, and the processing at step 502 described previously is applied. Due to this, correspondence data F″(L1, θ) of new L*a*b* values for the RGB values of the lattice points for the non-reference lens L1 is obtained. FIG. 11C is a diagram representing each color gamut in the L*a*b* color space by the two-dimensional coordinate position of L* and a*. In FIG. 11C, the solid line indicates the correspondence data F′(L0, θ) of the reference lens L0 and the alternate long and short dash line indicates the color measurement data F(L1, θ) of the non-reference lens L1 at the viewing angle θ. The correspondence data F′(L0, θ) of the reference lens L0 is subjected to gamut mapping so as to be included in the color measurement data F(L1, θ) of the non-reference lens L1, thereby the correspondence data F″(L1, θ) of the region indicated by slashes is obtained. The broken line indicates color measurement data F(L1, θref) in the case where color measurement is performed at the reference angle θ for the non-reference lens L1. In the case where the first embodiment is applied using this, the color measurement data F(L1, θ) of the non-reference lens L1 is subjected to gamut mapping toward this F(L1, θref), and therefore, it is known that the correspondence data obtained as a result of that does not agree with the above-mentioned correspondence data F″(L1, θ). Of course, even the LUT that realizes the correspondence data (correspondence data subjected to gamut mapping toward the color measurement data F(L1, θref)) obtained by applying the first embodiment does not cause a problem of the binocular rivalry in the case where there is not a large difference in colors reproduced between the left eye and the right eye as a result of correction using the LUT. In the present embodiment, a case where the difference becomes large and the binocular rivalry may occur is supposed and the difference in colors reproduced through the glasses between both eyes is also taken into account so as to prevent the binocular rivalry from occurring even in such a case.

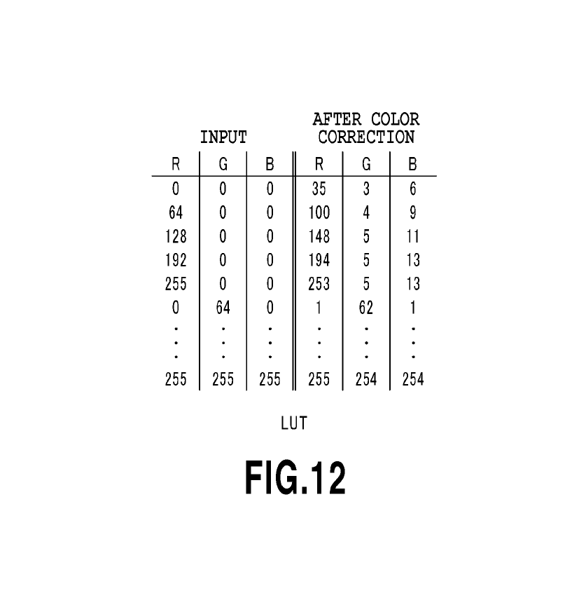

Finally, the L*a*b* values in the correspondence data F″(L1, θ) are converted into RGB values using the color measurement data F(L1, θ) and associated with the RGB values of the lattice points to be an LUT for the non-reference lens L1 (steps 503 to 504 in FIG. 5). FIG. 12 is a specific example of the LUT that realizes the correspondence data F″ (L1, θ) shown in FIGS. 11C and 11D. In the case of this LUT, for example, in a case where the value of a certain pixel in input image data is (R, G, B)=(64, 0, 0), the value of the pixel in the corrected image data is corrected to (R, G, B)=(100, 4, 9) as a result.

By performing the processing according to the flowchart in FIG. 3 explained in the first embodiment using the color correction parameters for various viewing angles θ created in advance as described above, it is made possible to suppress not only the change in colors depending on the viewing posture but also the binocular rivalry.

In the example described above, the colors viewed through the lens used as a reference are matched with the colors viewed through the other lens, however, a method for reducing the difference in the way colors are viewed between both eyes is not limited to this. For example, common target data F(Lt) is set, which specifies a group target colors corresponding to the RGB values of the lattice points (for example, target L*a*b* values). Then it may also be possible to perform color correction by creating color correction parameters for reproducing the target L*a*b* values for the left and right lenses, respectively, based on the common target data F(Lt). In this case, the common target data F(Lt) is designed so that the target L*a*b* values are included in the common color gamut in the case where the image display screen is viewed through the left and right lenses, respectively, at the reference angle θref or an arbitrary viewing angle θ, for example. That is, the common target color group F(Lt) included in the common region of the reproducible range of colors reproduced through the left and right lenses, respectively, is set. Then, the color measurement data F(L, θref) relating to the reference angle θref explained in the first embodiment is replaced with the common target data F(Lt) and by the procedure shown in the flowchart in FIG. 5, the LUT for each lens is created.

### Third Embodiment

In the first and second embodiments, the example in which color correction in accordance with the inclination of the glasses is performed in the 3D image display system using circular polarized glasses as dedicated glasses is explained. The present invention can also be applied to other 3D image display system.

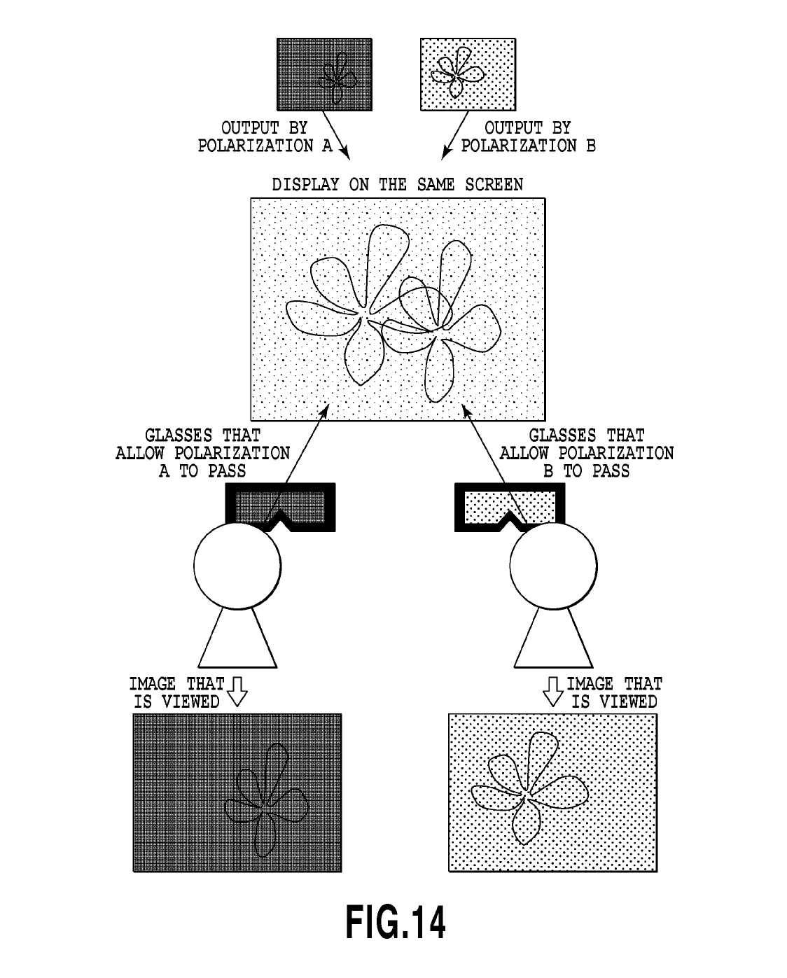

For example, the present invention is effective for a 3D image display system using dedicated shutter-system glasses utilizing a polarizing element and a simultaneous multi-image display system for providing images output by polarization to a plurality of viewers by distributing the images using dedicated glasses having different polarization characteristics (see FIG. 14).

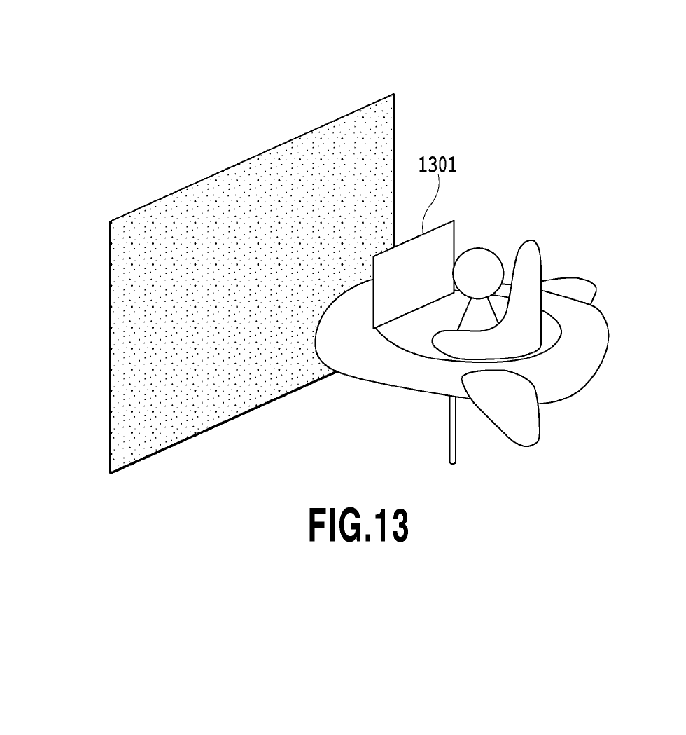

Further, it is also possible to apply the present invention to a ride attraction etc. as shown in FIG. 13 by regarding a polarizing plate 1301 that moves in conjunction with a viewer as glasses in a wide sense.

### Fourth Embodiment

In the first and second embodiments, the aspect in which color correction in accordance with the inclination of glasses is performed on input image data is explained. Next, an aspect is explained as a fourth embodiment, in which crosstalk that forms a factor to block viewing of a 3D video is cancelled by image processing as color correction. Explanation of the points common to the first and second embodiments is omitted and here, different points are explained mainly.

First crosstalk of a 3D video is explained.

Crosstalk of a 3D video is a phenomenon in which a video intended to be viewed by the left eye leaks to and viewed by the right eye; and a video intended to be viewed by the right eye leaks to and viewed by the left eye. Then, the color of crosstalk fluctuates depending on, for example, the optical characteristics of the dedicated glasses 120 using a polarizing film and further, fluctuates depending on the posture of a viewer (inclination of the glasses with respect to the sight-line direction as a rotation center).

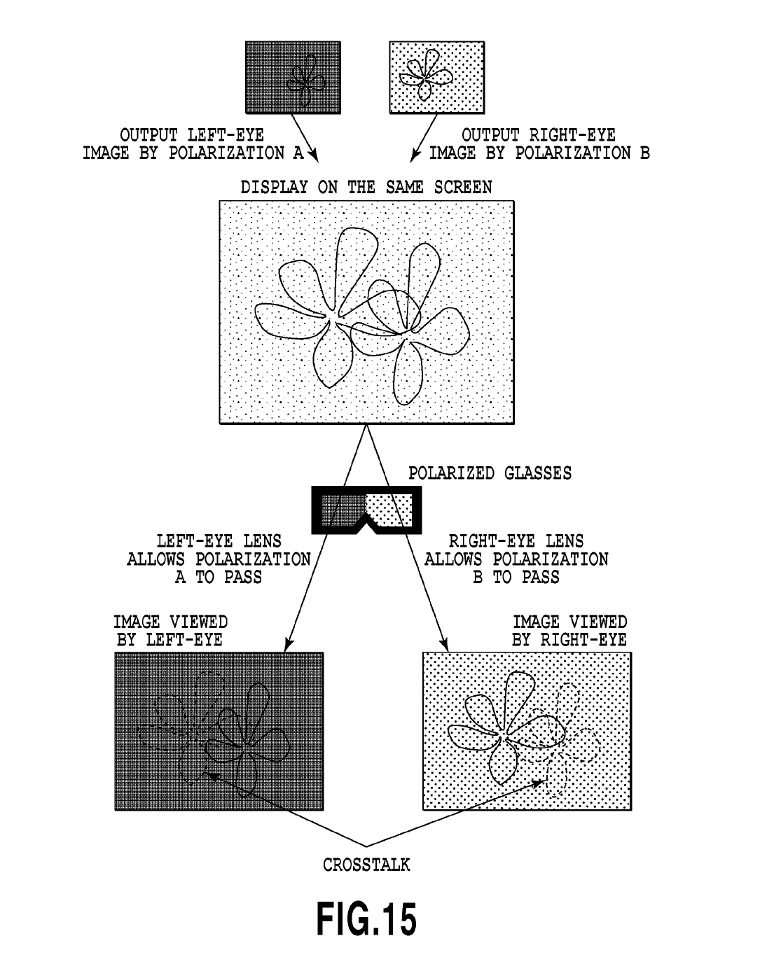

FIG. 15 is a diagram for explaining crosstalk. First, parallax image data including two kinds of image, that is, a left-eye image and a right-eye image, is input and polarization A is applied to the left-eye image and polarization B is applied to the right-eye image, and then they are output and displayed on the same screen. A viewer views the video through the dedicated glasses 120 to the left-eye glass of which a polarizing film of the polarization A is attached and to the right-eye glass of which a polarizing film of the polarization B is attached. As a result of this, it is ideal that only the left-eye image enters the left eye and only the right-eye image enters the right eye, however, in actuality, the image intended to be viewed by one of the eyes enters the other eye mixedly as crosstalk. FIG. 15 shows the way the video is viewed as a double image because of this crosstalk.

Next, color correction processing in the present embodiment is explained. In the color correction processing in the present embodiment, crosstalk correction processing is performed and a crosstalk corrected image is obtained as a color corrected image as a result of this. In the present embodiment, in addition to the color measurement data of the display device measured through the dedicated glasses 120, the color measurement data of crosstalk measured through the dedicated glasses 120 is prepared in advance, and crosstalk correction processing is performed using these data.

### (About Color Measurement of Display Device)

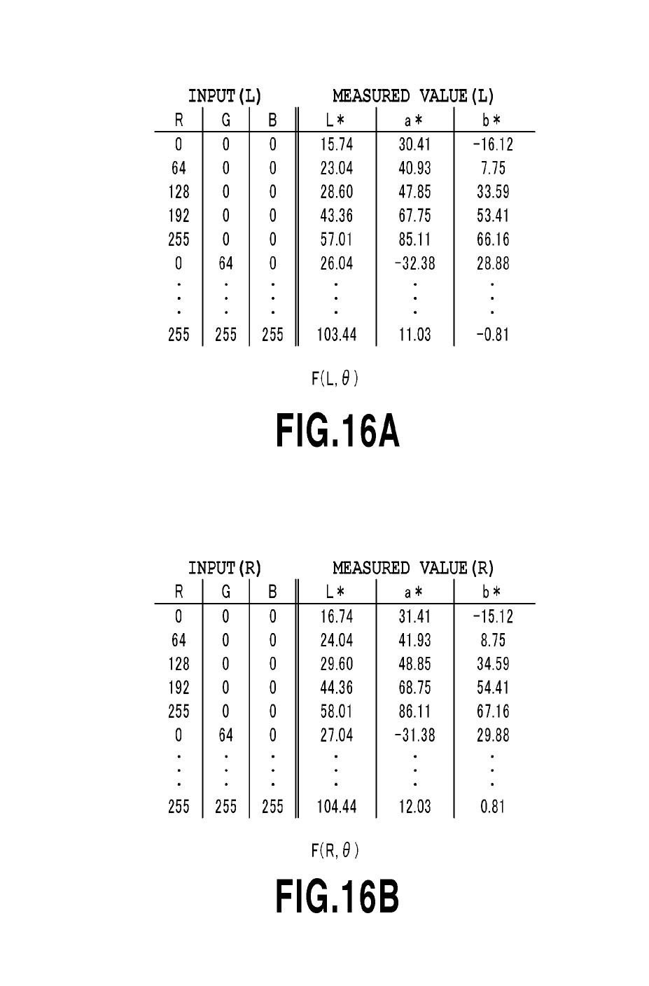

It is possible to obtain the color measurement data of the display device by the method explained at step 501 in the flowchart in FIG. 5 according to the first embodiment. Specifically, the RGB value corresponding to each lattice point generated by dividing the RGB color space into the form of a lattice is input to and displayed on the liquid crystal display 130, which is an image output device, and the color of the image display screen is measured. For color measurement, for example, a spectroradiometer is used and the dedicated glasses 120 are set to a predetermined viewing angle θ, and then, the color is measured through the lens. Then, such color measurement is performed repeatedly for the viewing angle θ at arbitrary intervals and in an arbitrary range as in the first embodiment, and the obtained XYZ value is converted into the L*a*b* value, and thus, the color measurement data F(L, θ) and F(R, θ) in which the L*a*b* value after conversion and the RGB value of the lattice point are associated are obtained. F(L, θ) is the color measurement data of the display device measured through the left-eye lens L; and F(R, θ) is the color measurement data of the display device measured through a right-eye lens R. Here, color measurement of F(L, θ) is performed in a state where the RGB value of the lattice point is displayed as the left-eye image, and the right-eye image is not displayed. On the contrary, color measurement of F(R, θ) is performed in a state where the RGB value of the lattice point is displayed as the right-eye image, and the left-eye image is not displayed. FIGS. 16A and 16B show specific examples of the color measurement data F(L, θ) and F(R, θ), respectively, of the display device obtained in this manner. The obtained color measurement data is stored in the HDD 204.

### (About Color Measurement of Crosstalk)

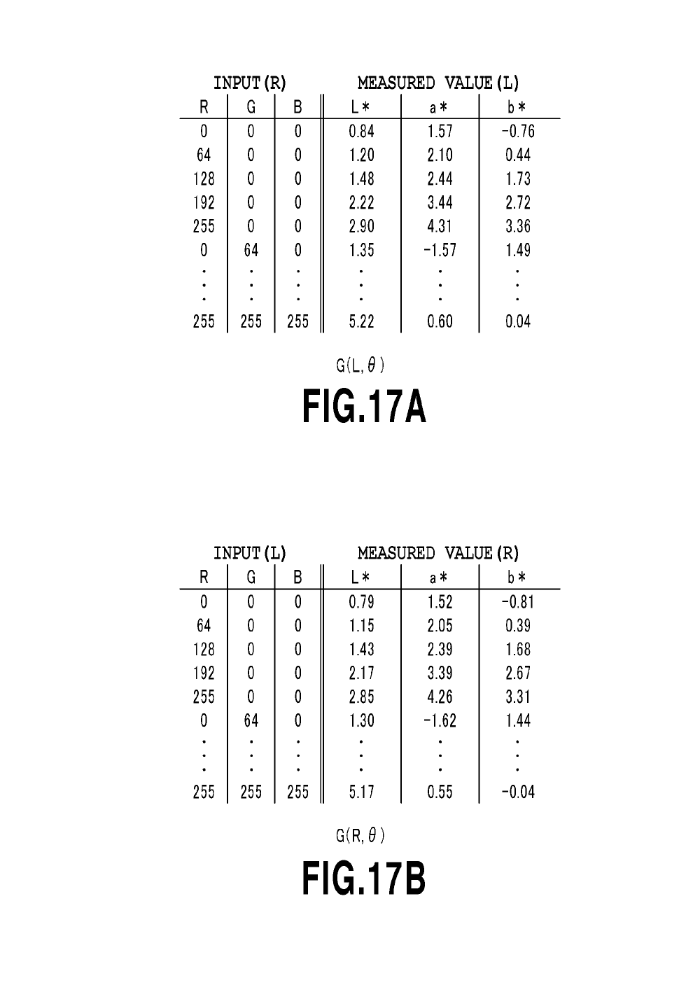

The basic flow of color measurement is the same as the color measurement of the display device, and therefore, detailed explanation is omitted, however, in the color measurement of crosstalk, the correspondence relationship between the lens through which color measurement is performed and the image to be displayed is different from that at the time of the color measurement of the display device described previously. Specifically, in the case where color measurement is performed through the left-eye lens L, color measurement is performed in the state where the RGB value of the lattice point is displayed as the right-eye image, and the left-eye image is not displayed. On the contrary, in the case where color measurement is performed through the right-eye lens R, color measurement is performed in the state where the RGB value of the lattice point is displayed as the left-eye image, and the right-eye image is not displayed. By doing so, it is possible to perform color measurement of the crosstalk through the left and right lenses, respectively. FIGS. 17A and 17B show specific examples of crosstalk measurement data G(L, θ) of the left-eye and crosstalk measurement data G(R, θ) of the right-eye, respectively. The obtained color measurement data is stored in the HDD 204.

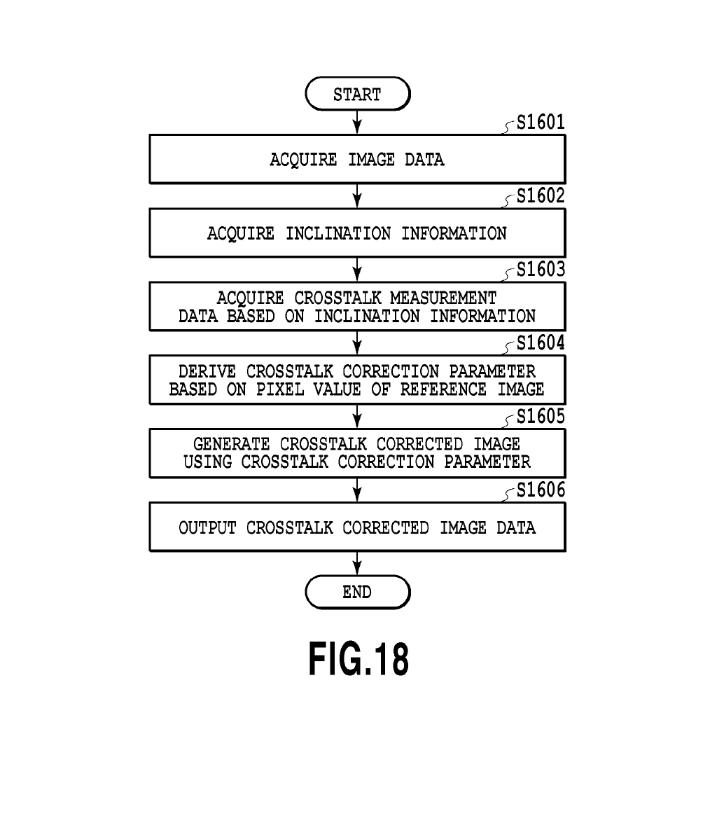

FIG. 18 is a flowchart showing a flow of crosstalk correction processing in the present embodiment. Part of steps are the same as the processing in the flowchart in FIG. 3 according to the first embodiment, and therefore, detailed explanation thereof is omitted.

At step 1601, the CPU 201 acquires image data to be displayed on the liquid crystal display 130. For example, it may also be possible for the CPU 201 to acquire image data from the digital camera 209 via the input I/F 206, or to acquire image data saved in a secondary storage device, such as the HDD 204, via the HDD I/F 205. The image data to be acquired (input) is parallax image data including two kinds of images, that is, a left-eye image and a right-eye image.

At step 1602, the CPU 201 acquires the inclination information of the dedicated glasses 120 from the inclination sensor 121. Details of the processing are the same as those of the processing at step 302 in the flowchart in FIG. 3, and therefore, explanation is omitted.

At step 1603, the CPU 201 acquires crosstalk measurement data corresponding to the left and right eyes, respectively, based on the inclination information acquired at step 1602. Specifically, the CPU 201 acquires the crosstalk measurement data G(L, θ) of the left-eye and the crosstalk measurement data G(R, θ) of the right-eye corresponding to the angle θ indicated by the acquired inclination information from the HDD 204. In the case where the crosstalk measurement data is created at, for example, five-degree intervals, there is a real possibility that crosstalk measurement data corresponding to the acquired inclination information (angle θ) does not exist. In this case, interpolation processing is performed using two pieces of crosstalk measurement data corresponding to two angles (θ0 and θ1) that satisfy θ0<θ<θ1, and then crosstalk measurement data corresponding to the acquired inclination information is derived. Further, in the case where crosstalk measurement data corresponding to the angles θ0 and θ1 does not exist, crosstalk measurement data of the angle closest to the acquired inclination information (angle θ) is selected and determined to be the crosstalk measurement data to be used. At the time of preparation of crosstalk measurement data in advance, the range and intervals of the angle are not limited to specific conditions, and it may be possible to set them by the same method used to acquire the color correction parameters in the first embodiment.

At step 1604, the CPU 201 derives crosstalk correction parameters corresponding to the left and right eyes, respectively, from pixel values of a reference image and the crosstalk measurement data. Here, the reference image refers to an image intended to be displayed on an eye opposite to an eye to be subjected to processing. Specifically, in the case where the crosstalk correction parameter for the left eye is derived, the right-eye image is taken to be the reference image, and in the case where the crosstalk correction parameter for the right eye is derived, the left-eye image is taken to be the reference image. The crosstalk correction parameters obtained at this step will be the L*a*b* values of the crosstalk corresponding to the RGB values of each pixel of the reference image. Specifically, in the case where a crosstalk correction parameter H(L) for the left eye is derived, it is possible to obtain it by taking the right-eye image to be the reference image and referring to the crosstalk measurement data G(L, θ) with the RGB value of each pixel of the reference image. It is possible to obtain a crosstalk correction parameter H(R) for the right eye by a method opposite to that described above, that is, by taking the left-eye image to be the reference image and referring to the crosstalk measurement data G(R, θ) with the RGB value of each pixel of the reference image. In the case where there is an RGB value that does not correspond to the crosstalk measurement data (that is, which does not agree with a lattice point) within the reference image, it may possible to obtain the crosstalk correction parameter by performing interpolation processing, such as tetrahedral interpolation, from lattice points in the vicinity thereof.

At step 1605, the CPU 201 corrects the pixel value of the parallax image data input at step 1601 using the crosstalk correction parameter derived at step 1604 and generates crosstalk corrected image data (color corrected image data). Similar to the parallax image data that is input, the crosstalk corrected image data also includes a left-eye crosstalk corrected image and a right-eye crosstalk corrected image. Hereinafter, how the pixel value of the parallax image data is corrected is explained specifically using generation of a left-eye crosstalk corrected image as an example.

First, by referring to the color measurement data F(L, θ) of the display device measured through the left-eye lens L with the RGB value of the left-eye image, which is the input image acquired at step 1601, the L*a*b* value of the left-eye image is obtained. In the case where there is an RGB value that does not correspond to the color measurement data (that is, which does not agree with a lattice point) within the left-eye image, it may be possible to obtain the L*a*b* value corresponding to the RGB value, which is the target of the processing, by performing interpolation processing, such as tetrahedral interpolation, from lattice points in the vicinity thereof.

Next, the crosstalk correction parameter H(L) derived at step 1604 is subtracted from the obtained L*a*b* value of the left-eye image, thereby the L*a*b* value of the left-eye crosstalk corrected image is obtained.

Finally, the RGB value of the left-eye crosstalk corrected image is obtained by inversely converting the L*a*b* value of the left-eye crosstalk corrected image into the RGB value based on the color measurement data F(L, θ) of the display device measured through the left-eye lens L. In the case where the RGB value after the conversion takes a negative value or a value larger than 256, it may be possible to perform clipping processing appropriately. By the same method, a right-eye crosstalk corrected image is also generated.

At step 1606, the CPU 201 sends the generated crosstalk corrected image data to the liquid crystal display 130. Then, on the liquid crystal display 130, the crosstalk corrected image data is displayed.

By the color correction processing as described above, correction of crosstalk is performed in accordance with the inclination of glasses, and therefore, it is made possible to suppress occurrence of crosstalk depending on the viewing posture.

In the present embodiment, it is suggested to perform clipping processing in the case where the RGB value of the crosstalk corrected image takes a negative value, however, there is a possibility that trouble, such as color transition, occurs resulting from this processing. Because of this, for example, it can be thought to offset the pixel value of the input image in advance by an offset amount derived in accordance with the value of crosstalk. Due to this, it is possible to prevent the RGB value from taking a negative value after correction and to suppress crosstalk more without causing color transition. The offset amount in this case may be changed appropriately in accordance with the inclination of the glasses. Further, the value of crosstalk at the time of derivation of the offset amount is set to the maximum value within the crosstalk measurement data, for example. Of course, it is needless to say that the offset amount may be changed appropriately for each input image.

It can also be thought that the crosstalk corrected image data generated by the crosstalk correction processing explained in the present embodiment would produce new crosstalk. It is possible to suppress this by sequentially updating the crosstalk corrected image data corresponding to the left and right eyes using the generated crosstalk corrected image data as new input image data. It may be possible to set the iteration count of update of the crosstalk corrected image data in such a manner that, for example, a tolerance of crosstalk is determined in advance and the update is repeated until the crosstalk correction parameter becomes smaller than the tolerance.

Further, it may also be possible to simultaneously perform the color correction processing explained in the first and second embodiments and the crosstalk correction processing explained in the present embodiment. That is, it may also be possible to perform the crosstalk correction processing explained in the present embodiment using F′(L, θ) and F″(L, θ) in place of F(L, θ).

### Fifth Embodiment

In the fourth embodiment, the aspect is explained, in which color measurement of crosstalk is performed in advance for various rotation angles, and correction of crosstalk is performed in accordance with the inclination of the glasses using the obtained color measurement data. Next, an aspect is explained as a fifth embodiment, in which color measurement of crosstalk is performed only for the rotation angle at which crosstalk occurs most strongly, for example, and for other angles, the color of crosstalk is derived by interpolation calculation. Explanation of points common to those in the fourth embodiment is omitted and here, different points are explained mainly.

First, color measurement of crosstalk in the present embodiment is explained.

In the present embodiment, color measurement of crosstalk is performed only for the rotation angle of the dedicated glasses 120 at which crosstalk occurs most strongly. The rotation angle at which crosstalk occurs most strongly differs depending on the optical characteristics etc. of the polarizing film of the dedicated glasses 120 and here, it is assumed that crosstalk occurs most strongly in a case where the rotation angle is 90 degrees. In this case, color measurement of crosstalk is performed by the same method as that in the fourth embodiment in the state where the dedicated glasses 120 are rotated through 90 degrees and fixed. By this, left-eye crosstalk measurement data G(L, 90 degrees) and right-eye crosstalk measurement data G(R, 90 degrees) are obtained.

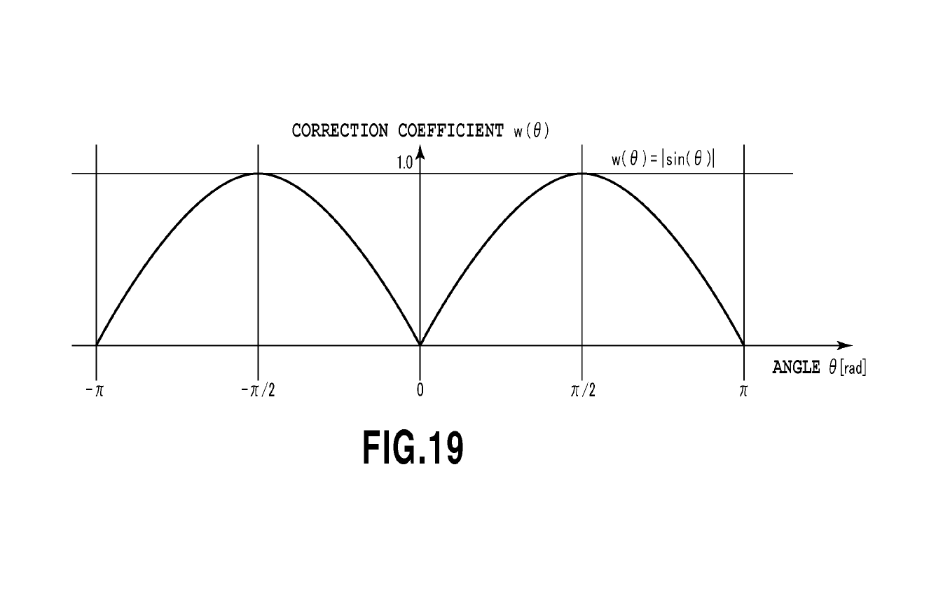

Next, a method for deriving crosstalk measurement data in accordance with the inclination information of the dedicated glasses 120 is explained. In the present embodiment, based on the optical characteristics of the dedicated glasses 120, the amount of change in luminance of crosstalk is approximated by an absolute value of the sine thereof and this is taken to be a crosstalk correction coefficient W(θ) in accordance with the rotation angle. FIG. 19 shows a graph of the crosstalk correction coefficient. In the present embodiment, the amount of change in luminance of crosstalk is approximated by an absolute value of the sine thereof, however, it is necessary to appropriately define this approximation function in accordance with the optical characteristics of the dedicated glasses. Then, by multiplying the crosstalk measurement data G(L, 90 degrees) and G(R, 90 degrees) by this crosstalk correction coefficient W(θ), it is possible to derive the crosstalk measurement data corresponding to the target rotation angle.

By performing the crosstalk correction processing explained in the fourth embodiment using the crosstalk measurement data obtained in the manner described above, it is made possible to suppress occurrence of crosstalk depending on the viewing posture while reducing the number of processes relating to crosstalk color measurement.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-139989, filed Jun. 21, 2012, 2013-076145, filed Apr. 1, 2013 which are hereby incorporated by reference herein in their entirety.

What is claimed is:

1. An image processing device for an image display system including glasses having polarizing elements and an image display device, the image processing device comprising:
a color correction unit configured to perform color correction processing on image data indicating an image to be displayed based on inclination information of the glasses with respect to a display screen of the image display device.

2. The image processing device according to claim 1, wherein
the inclination information of the glasses is a rotation angle of the glasses with respect to a horizontal axis in a plane parallel to the display screen of the image display device.

3. The image processing device according to claim 1, wherein
the color correction unit acquires a color correction parameter used for the color correction processing from a plurality of color correction parameters associated with a plurality of rotation angles based on the inclination information of the glasses.

4. The image processing device according to claim 1, wherein
the color correction parameters are those by which a group of target colors determined in advance are reproduced.

5. The image processing device according to claim 4, wherein
the group of target colors are a group of colors reproduced through the glasses in a case where the inclination of the glasses is horizontal.

6. The image processing device according to claim 1, wherein
the color correction parameters are those by which a difference in colors reproduced through the glasses between both eyes becomes small.

7. The image processing device according to claim 6, wherein
the color correction parameters are those by which a group of target colors determined in advance are reproduced for a lens used as a reference, which is one of left and right lenses constituting the glasses, and by which colors that are reproduced through the lens used as the reference are reproduced for the other lens.

8. The image processing device according to claim 7, wherein
the lens used as the reference is a lens on the side corresponding to the dominant eye of a viewer.

9. The image processing device according to claim 7, wherein
the lens used as the reference is selected based on a reproducible range of colors reproduced through the glasses determined in accordance with the inclination information.

10. The image processing device according to claim 6, wherein
the color correction parameters are those by which a common group of target colors determined in advance are reproduced for each of left and right lenses constituting the glasses.

11. The image processing device according to claim 10, wherein
the common group of target colors are included in a common range of a color reproducible range of colors reproduced through the left and right lenses, respectively.

12. An image processing method for an image display system including glasses having polarizing elements and an image display device, the image processing method comprising the steps of:
performing color correction processing on image data indicating an image to be displayed based on inclination information of the glasses with respect to a display screen of the image display device.

13. A non-transitory computer readable storage medium storing a program for causing a computer to perform the image processing method according to claim 12.

14. An image processing device for an image display system including glasses having polarizing elements and an image display device, the image processing device comprising:
a color correction unit configured to perform color correction processing on image data indicating an image to be displayed based on inclination information of the glasses with respect to a display screen of the image display device and a pixel value of a reference image.

15. The image processing device according to claim 14, wherein
color correction processing performed by the color correction unit is crosstalk correction processing.

16. The image processing device according to claim 14, wherein
the reference image is an image different from an image to be processed in parallax images including two kinds of images which are a left-eye image and a right-eye image.

17. The image processing device according to claim 14, further comprising an offset unit configured to offset a pixel value of image data to be displayed.

18. The image processing device according to claim 17, wherein
the offset unit offsets a pixel value of image data to be displayed by an offset amount set based on a value of crosstalk.

19. The image processing device according to claim 18, wherein
the value of crosstalk is a maximum value within crosstalk measurement data.

20. The image processing device according to claim 18, wherein
the offset amount is changed for each piece of image data to be displayed.

21. The image processing device according to claim 14, wherein
color correction processing is performed repeatedly on color corrected image data obtained by the color correction unit as a new target of color correction processing.

22. The image processing device according to claim 21, wherein,
an iteration count of color correction processing is derived based on a tolerance of crosstalk set in advance.

23. The image processing device according to claim 14, further comprising:
a crosstalk color measurement unit configured to perform color measurement of crosstalk only for the inclination of the glasses at which crosstalk occurs most strongly;
a unit configured to derive a crosstalk correction coefficient from an amount of change in luminance in a case where the glasses are rotated; and
a unit configured to derive crosstalk measurement data corresponding to a specific rotation angle from crosstalk measurement data obtained by the crosstalk color measurement unit and the crosstalk correction coefficient.

24. An image processing method for an image display system including glasses having polarizing elements and an image display device, the image processing method comprising the steps of:
performing color correction processing on image data indicating an image to be displayed based on inclination information of the glasses with respect to a display screen of the image display device and a pixel value of a reference image.

25. A non-transitory computer readable storage medium storing a program for causing a computer to perform the image processing method according to claim 24.
